(19) United States
(12) Patent Application Publication
(10) Pub. No.: US 2009/0123163 A1
(43) Pub. Date: May 14, 2009

(54) METHOD OF PRODUCING A HIGHLY PERMEABLE STABLE RF WAVEFRONT SUITABLE AS A DATA CARRIER

(76) Inventor: James Cornwell, Irvine, CA (US)

Correspondence Address: BUCHANAN, INGERSOLL & ROONEY PC, POST OFFICE BOX 1404, ALEXANDRIA, VA, 22313-1404, US

(21) Appl. No.: 12/269,880

(22) Filed: Nov. 12, 2008

Related U.S. Application Data
(60) Provisional application No. 60/987,195, filed on Nov. 12, 2007.
(60) Provisional application No. 60/987,691, filed on Nov. 13, 2007.
(60) Provisional application No. 61/113,847, filed on Nov. 12, 2008.

(51) Int. Cl. H04B 10/04

(52) U.S. Cl. 398/183

(57) ABSTRACT

A method for generating a highly permeable stable broadband wavefront includes generating a modulated photon wave associated with a modulated data signal, the modulated photon wave comprising plural energized particles, directing the modulated photon wave to an incident surface of a charge transformer and transforming the plural energized particles within the charge transformer. The transformed particles are at substantially zero charge. The method also includes generating a wavefront at an exit surface of the charge transformer including the transformed particles at substantially zero charge.

### CROSS-REFERENCE TO RELATED APPLICATIONS

This application claims priority from U.S. Provisional Patent Application Ser. Nos. 60/987,195, filed Nov. 12, 2007, and 60/987,691, filed Nov. 13, 2007, the disclosures of which are hereby incorporated by reference in their entirety. This application also incorporates by reference in its entirety U.S. Provisional Patent Application Ser. No. 61/113,847, filed Nov. 12, 2008.

PCT International Pub. No. WO2006/086658 titled “Antenna System,” which is a continuation of International Application Number PCT/US2006/004779, filed Feb. 13, 2006, is incorporated by reference herein in its entirety. U.S. Pat. No. 7,221,329 titled “Enhanced Beam Antenna,” dated May 22, 2007, is also incorporated by reference herein in its entirety.

### BACKGROUND

1. Field

The subject matter presented herein relates generally to wireless communications systems, and more particularly, to producing a stable wavefront using a directed particle wave impinging on a charge transformer.

2. Description of Related Art

Known communications systems can feature the transmission of a signal using a carrier frequency that has been modulated in, for example, either the amplitude or time domains, or a combination of both. Such a signal can be typically provided with data that is fed to a modulator that alters the amplitude or phase of a sinusoidal electronic signal that is then fed to an antenna as a time-varying voltage and current. Depending on the power levels and antenna configuration, a radiation pattern can be generated that propagates through space and can be detected and amplified by a receiver tuned to a same frequency.

Such systems can be typically characterized as having an operating frequency in the radio frequency (RF) bands from about 50 KHz to 3 GHz. These bands can be highly regulated by government agencies to ensure that operations in one frequency band interfere with operations in another frequency band. Also, due to the limited number of frequency bands available, such bands can be expensive to license.

There can be several issues associated with known communications systems. An issue can be interference between neighboring communications systems that may be operating at or near a particular frequency, both with regard to the fundamental carrier frequency or the principal harmonic frequencies associated with each transmission within the individual communications systems.

An example is when a high power transmitting station generates a secondary harmonic frequency transmission signal having a power level that may be significantly higher than the power level of a primary signal of a local communication system, which results in the local communication signal being overridden by the more powerful signal, thereby possibly blocking effective local communications.

Similarly, communications radiating along paths between a transmitter and target receivers can be subject to physical degradations and frequency shifting due to such factors such as relative motions of the communications devices, parasitic reflections from physical objects located along the communications path that can create dual signal ghosting effects, and environmental and weather effects, to name several examples. Additionally, component age degradation within various components of a communications system can create additional frequency disturbances that can contribute to spillover into adjacent frequency bands and thus can interfere with adjacent communications systems,

### SUMMARY

In an exemplary embodiment, a method for producing a stable communications wavefront comprises generating a modulated photon wave associated with a modulated data signal, the modulated photon wave comprising plural energized particles; directing the modulated photon wave to an incident surface of a charge transformer; transforming the plural energized particles within the charge transformer, wherein the transformed particles are at substantially zero charge; and generating a wavefront at an exit surface of the charge transformer comprising the transformed particles at substantially zero charge.

### BRIEF DESCRIPTION OF THE DRAWINGS

As will be realized, different embodiments are possible, and the details disclosed herein are capable of modification in various respects, all without departing from the scope of the claims. Accordingly, the drawings and descriptions are to be regarded as illustrative in nature and not as restrictive. Like reference numerals have been used to designate like elements.

FIG. 1 shows a functional block diagram of an exemplary embodiment of a communications apparatus.

FIG. 2 shows a simplified cross-sectional view of portions of an exemplary embodiment of a communications apparatus.

FIG. 3 shows a flow chart for an exemplary wavefront generation method.

### DETAILED DESCRIPTION

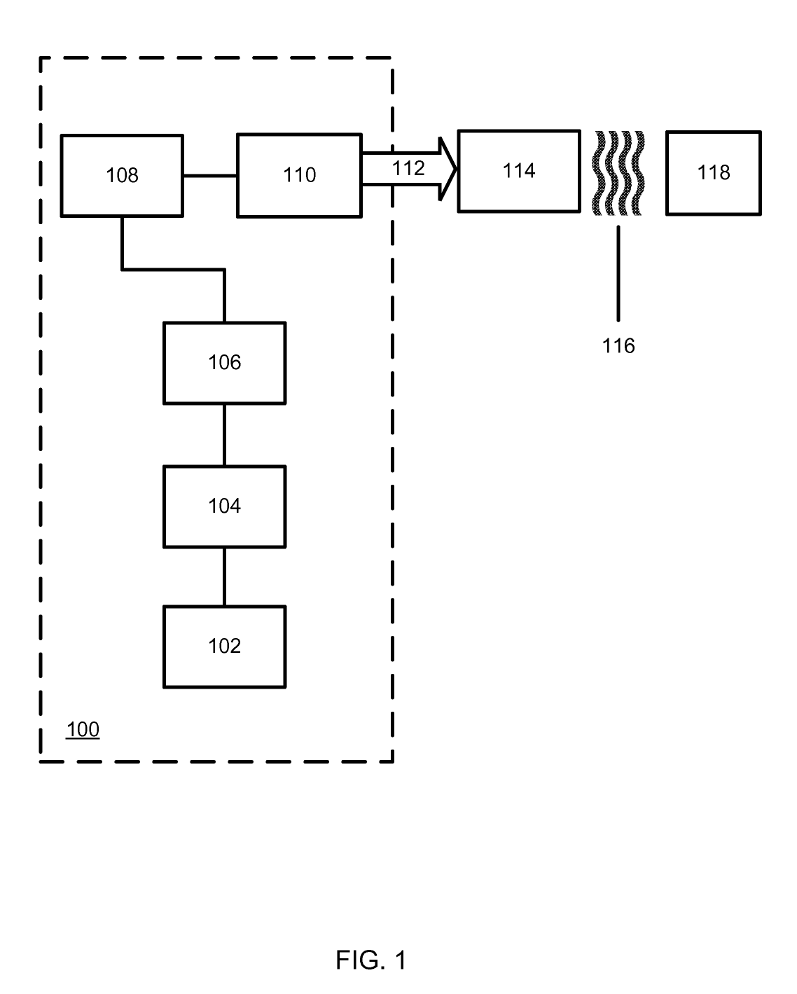

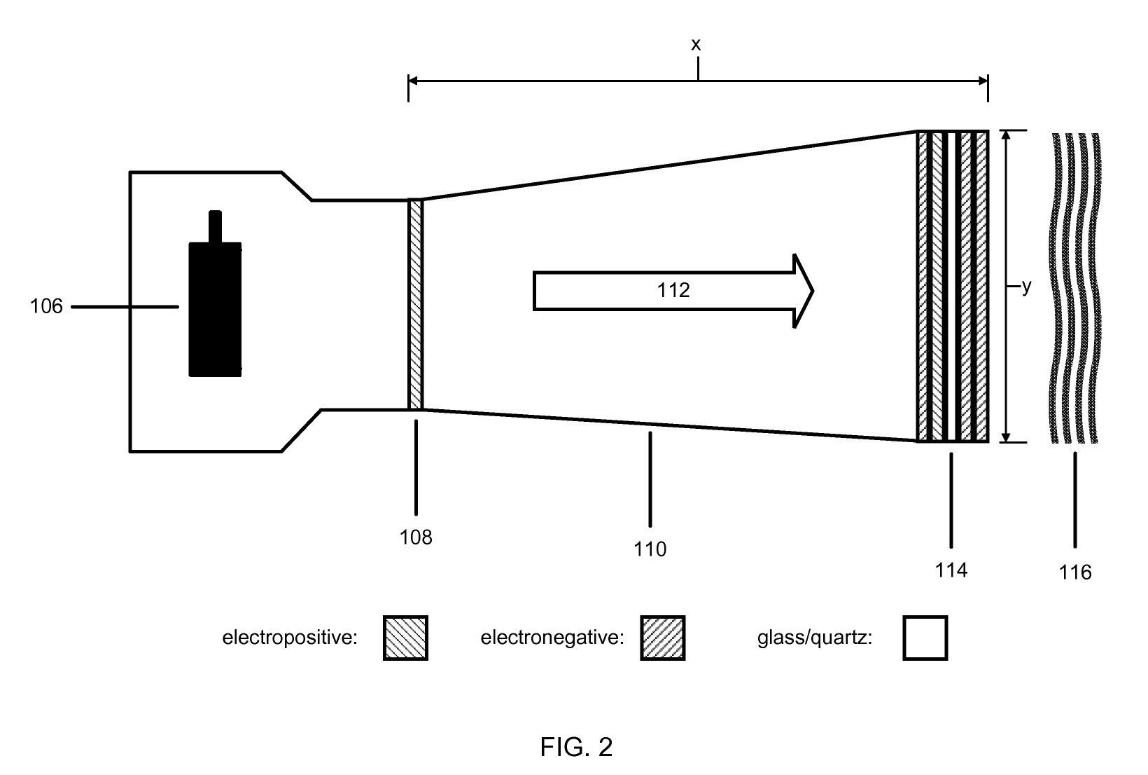

Referring to FIGS. 1 and 2, exemplary embodiments of a communications system can include a charged particle generator 100 configured to generate plural energized particles and a charge transformer 114 configured to receive the plural energized particles that include charged particles from the charged particle generator and to output energized particles that include particles having substantially zero charge. The charged particle generator 100 can be configured to direct the plural energized particles through the charge transformer 114 to propagate through free space until received by a broadband signal receiver 118, for example, which can demodulate a data signal to complete the data communication.

In an exemplary embodiment, the plural energized particles can be in the form of a photon particle wave, e.g., a mixture or cross-generation of photons and electrons.

Power and control components will be known to those of skill in the art. For example, in an exemplary embodiment, energized particle generator 100 can include a DC power supply 102 and DC-to-AC converter 104.

In an exemplary embodiment, charged particle generator 100 can include charged particle emitter 106. In an embodiment, charged particle emitter 106 can include any source of radio frequency energy, particularly microwaves. In some embodiments, charged particle emitter 106 may include known magnetrons. In some other embodiments, charged particle emitter 106 may include solid-state power amplifiers, gyrotrons, traveling wave tubes (TWTs), and/or klystrons. In some embodiments, charged particle emitter 106 may be a lower-power source and may generate energy levels of approximately 1 kilowatt (kW) to approximately 100 kW or greater, although the scope is not limited in this respect.

In an exemplary embodiment, in charged particle emitter 106, an RF data signal to be communicated can be formed using known wireless communications techniques. The RF data signal can be combined with an excitation signal, which can form a modulated photon wave. In an embodiment, the RF data signal can be transmitted to a plurality of directional antenna devices, for example, which may be included in waveguide 110. By the amplification of the RF data signal to a very high signal voltage and subsequent application of this amplified RF data signal to the directional antenna devices, an ionic discharge at the antennas can occurs that can transform the RF data signal into a directed particle beam.

In an embodiment, waveguide 110 can be configured to minimize backscatter of the energized particles using known techniques. For example, using a plurality of backscatter reflectors, which can be included in waveguide 110 in proximity to the directional antennas, the particle beam can then be further focused and directed via waveguide 110 as an electromagnetic wavefront 112 to impinge on the surface of charge transformer 114.

Without limiting the scope of the invention, other examples of suitable charged particle emitters that can form a photon particle wave include known energy emission devices such as free electron lasers and discharges or arcs at edges of planar antennae, for example, spark gap generators.

In some embodiments, charged particle emitter 106 may include a free electron laser, or FEL. A FEL is a laser that shares the same optical properties as conventional lasers such as emitting a beam consisting of coherent electromagnetic radiation which can reach high power, but which uses some very different operating principles to form the beam. Unlike gas, liquid, or solid-state lasers such as diode lasers, which rely on bound atomic or molecular states, FELs use a relativistic electron beam as the lasing medium, hence the term free electron. This gives them a wide frequency range compared to other laser types, and makes many of them widely tunable, currently ranging in wavelength from microwaves, through terahertz radiation and infrared, to the visible spectrum, to ultraviolet, to soft X-rays.

In an exemplary embodiment, charged particle emitter 106 can include an excitation signal, produced by known signal generation devices, for example. Such an excitation signal could be a 120 VAC clipped (square) wave that can have an effect of driving a magnetron outside of a typical 2.45 GHz frequency, for example. In an embodiment, when a 120 VAC square wave excitation signal is applied to a magnetron, bandwidths on the order of 0 to 10 GHz can be achieved.

In an exemplary embodiment, the output of charged particle emitter 106 can be a photon particle wave that can include a mixture of photons and electrons.

In an exemplary embodiment, charged particle generator 100 can include an energized particle, e.g., photon and/or particle beam or wave, forming module 108. In an exemplary embodiment, energized particle (photon particle beam or wave) forming module 108 can be positioned in a throat section of a waveguide launcher between charged particle emitter 106 and waveguide 110.

In an exemplary embodiment, energized particle forming module 108 can be made of an electropositive material, such as a polycarbonate sheet. In an embodiment, this material can include DELRIN manufactured by DuPont. In an embodiment, energized particle forming module 108 can act like a roughing filter, i.e., it can start the process of reducing the charge of the charged particles in the mixture of photons and electrons. After passing through energized particle forming module 108, the mixture of photons and electrons can then be directed via waveguide 110 as an electromagnetic wavefront 112 to impinge on the surface of charge transformer 114.

In an exemplary embodiment, waveguide 110 can include a hollow conducting tube, which may be rectangular or circular, for example, within which EM waves can be propagated. Signals can propagate within the confines of metallic walls, for example, that act as boundaries.

In an exemplary embodiment, waveguide 110 can be configured as a circularly polarized antenna and may radiate substantially circularly polarized energy. In other embodiments, waveguide 110 may be linearly polarized and may radiate signals with a linear polarization (e.g., a horizontal and/or a vertical polarization). Antennas in many shapes, such as horns, lenses, planar arrays, and reflectors may be suitable in some of these embodiments.

As shown in FIG. 2, exemplary waveguide 110 can be configured as part of a device that can include a magnetron portion, a throat section of a waveguide launcher area that can include energized particle forming module 108 positioned between charged particle emitter 106 and waveguide 110, and a cone-like portion or horn. In an exemplary embodiment, a magnetron can be placed in the magnetron portion such that there can be a three-inch gap between the top of the magnetron's cathode and the top of the enclosure.

In an exemplary and non-limiting embodiment, waveguide 110 can be designed to promote sufficient velocity of the photon particle wave that can include a mixture of photons and electrons particles, here designated as EM wavefront 112, moving through the waveguide 110. Again referring to FIG. 2, x refers to a length of exemplary waveguide 110 (which can include energized particle forming module 108) and y refers to a height of an aperture opening at the end of waveguide 110. In an exemplary embodiment, the ratio of x/y can be approximately 3 to 3.5 to 1 to promote sufficient velocity of the particles moving through the waveguide 110. For example, assuming that the aperture opening height (y) is six inches, then waveguide 110 length can be from 18 to 21 inches. In another embodiment, a length of waveguide 110 can be based on the ratio of six times the air gap above an exemplary magnetron's cathode. Using the previously mentioned three-inch gap, this results in a waveguide length of eighteen inches.

In an exemplary embodiment, the aperture opening can be generally rectangular. In an embodiment, the aperture opening width can be eight inches for an aperture opening height (y) of six inches. In an exemplary embodiment, the length of the launcher area before the waveguide 110 can be approximately two inches.

In an exemplary embodiment, the interior surface of exemplary waveguide 110 can be coated with approximately two mils (0.002 inches) of a noble metal, such as 14-carat gold. Other noble metals can include ruthenium, rhodium, palladium, osmium, iridium and platinum. Such a coating can improve the gain characteristics of waveguide 110. An example of a suitable coating process that can be used to enhance the performance of antennas or waveguides may be found in U.S. Pat. No. 7,221,329, the disclosure of which is hereby incorporated by reference in its entirety.

In an exemplary embodiment, EM wavefront 112 can be directed through charge transformer 114. In an embodiment, charge transformer 112 can have dielectric and physical characteristics such that the energized charged particles, e.g., electrons, in an EM wavefront 112 can be transformed. While not wishing to be bound by any particular theory, this may be done either by changing characteristics of the particle, or by generation or emission of different particles as a result thereof, thereby creating a wavefront 116 at the output of the charge transformer 114. Wavefront 116 can have the modulation properties of the original RF data signal and propagate through free space until received by broadband signal receiver 118, for example, which can demodulate a data signal to complete the data communication.

In an exemplary embodiment, a 600 W magnetron can produce a wavefront 116 of about 10 mW/cm2 at the aperture, which can result in about 2 mW/cm2 at 1 meter from the aperture.

In an exemplary embodiment, charge transformer 114 can include an incident surface for receiving the EM wavefront 112 and an exit surface for radiating the wavefront 116.

In an exemplary embodiment, charge transformer 114 can include a composite of glass and/or polycarbonate materials, for example, and can vary in shape. For example, flat plates or panes with parallel surfaces can be used as well as convex lenses of a desired focal length. Hybrid configurations with parallel surfaces at the center and convex surfaces at the edges can also be acceptable configurations.

Referring to FIG. 2, in an exemplary embodiment, charge transformer 114 can include at least one electronegative/electropositive material pair, i.e., an electronegative layer next to an electropositive layer, or vice versa, that first receives EM wavefront 112, followed by approximately ½ inch of glass or quartz, followed by two electronegative layers. In an exemplary embodiment, this assembly of layers can be vacuum-sealed in ABS plastic.

Suitable materials for the electronegative/electropositive material pair can include known materials that can exhibit electronegative/electropositive behavior. As previously mentioned, an electropositive material can include a polycarbonate sheet made of DELRIN, for example. Suitable polycarbonate can also be chosen for electronegative layers. In another embodiment, plate glass can be sputtered with metal oxides to achieve desired electronegative/electropositive behavior.

In an exemplary embodiment, the approximately ½ inch of glass layer can include leaded glass if additional dampening of the emitted zero-charge particle stream is desired.

In an exemplary embodiment, there can be plural pairs of electronegative/electropositive material that first receives EM wavefront 112 followed by a glass or quartz layer.

In an exemplary embodiment, horizontal and/or vertical slits or other openings can be formed into or cut out of charge transformer 114 so that in addition to wavefront 116 propagating from charge transformer 114, charged particles in EM wavefront 112 can also propagate from the device. A controlled amount of charged particles along with wavefront 116 may be useful depending on the operating environment. In an exemplary embodiment, the slits or other openings may be adjustable by an operator using known methods and/or materials. For example, tape, a slide mechanism, or an aperture mechanism could be used to adjust the slits.

Charge transformer 114 may incorporate known coating materials or multiple deposition layers on either the incident surface or the exit surface to aid in the wavefront 116 generation, and/or have abrasion or polishing performed on either surface to enhance desired characteristics of the charge transformer 114. Similarly, side surfaces may have similar operations performed to enhance the desired charge transformer 114 characteristics. Other compositions materials and combinations of materials may be used in the fabrication of the charge transformer 114 to achieve desired transformation effects. Additionally, other geometries may be used for charge transformer 114, including, without limitation, stacking additional charge transformer components in combinations that may reflect, refract or redirect EM wavefront 112.

In an exemplary embodiment, wavefront 116, after exiting charge transformer 114, is shown in FIGS. 1 and 2 propagating through free space until received by a broadband signal receiver 118, for example, which can detect, convert, and demodulate the data signal to complete the data communication. In an embodiment, known antennas may not be useful for receiving at receiver 118, since the wavefront 116 can appear as a noise floor. The quantum photon wave may be detected using quantum physics techniques, such as, for example, photon detectors, such as solar arrays.

In an exemplary embodiment, a sighting device, such as a laser, rifle scope or sight, can be incorporated into an exemplary directed-energy system and used to help direct the wavefront 116.

Transforming the plural energized particles within the charge transformer can include laterally aligning the plural energized particles to produce a polarization of the plural energized particles. The plural energized particles can be generated by cross-generation of photons and electrons.

Various system components described above may be resized depending on the system parameters desired. For example, charge transformer 114 and waveguide 110 can be made larger or smaller and can have different dimensions and geometries depending, for example, on the power or distance requirements of a particular application. Additionally, an exemplary charged particle emitter 106 may be configured by those skilled in the art to have multiple voltages, frequencies, and power levels.

The precise theory of operation of the charged particle generator 100 in combination with the charge transformer 114 is not entirely understood. Without wishing to be bound by any theory, it is believed that the charge transformer 114 reduces the charge in the EM wavefront 112. Based on empirical data to date, it has been determined through experimentation, using, for example, exemplary embodiments described herein, that the particles in wavefront 116 are at a zero-charge state and approximately the same mass as an electron (9.10938188×10-31 kilograms).

While reiterating that the precise theory of operation is not entirely understood, it is believed that the effect is such that when a wavefront of exemplary zero-charge particles with sufficient energy density impinges a circuit, for example, the kinetic energy of the particles, rather than an associated electromagnetic charge, causes a resonant frequency. This resonant frequency may cause mechanical or physical oscillations.

In an exemplary embodiment, directional planar antennas, as described in the referenced PCT International Pub. No. WO2006/086658 titled “Antenna System,” can be used to create and focus a directed particle beam, thereby enhancing signal carrier performance in a wireless communications system. A brief description of an example of one such antenna will be described to aid in the understanding of the embodiments disclosed herein.

Typically, an antenna can include a first insulating substrate extending in the principal plane of the antenna. The antenna can further include a first radiating element and a connected first conductor and can include a second radiating element and a connected second conductor. The antenna can further include a coupling conductor coupling the second radiating element and the first conductor. The first antenna can further include a first coupler having a first signal conductor and a second signal conductor. The first signal conductor can be coupled to the second conductor, and the second signal conductor can be coupled to the first radiating element.

In an exemplary embodiment, when RF signal currents are applied between the first and second signal conductors, radiating elements can resonate and operate as an antenna. The radiation that emanates from a radiating element can tend to emanate from the edge of the element, e.g., the edge of an etched copper, generally flat, shape. By incorporating a plurality of such antennas, each having a different principal plane or orientation, and where each may have a custom configuration, a composite radiation field pattern can be shaped and made highly directional. Each antenna configuration may be varied by size and shape to meet frequency requirements and impedance matching requirements according to known “patch radiator” technology. Such directional radiation effects can be incorporated in the embodiments disclosed herein.

In an exemplary embodiment, receiver 118 can be configured substantially the same as shown in FIG. 2. A difference can be that in place of a magnetron, for example, a frequency downconverter using a pendulum, for example, can be configured to receive the zero-charge particles. As previously mentioned, the kinetic energy of the particles, rather than an associated electromagnetic charge, can cause a resonant frequency. This resonant frequency may cause mechanical or physical oscillations, which may be converted by an exemplary frequency downconverter using a pendulum. The resulting signal can then be output to a suitable analyzer, for example.

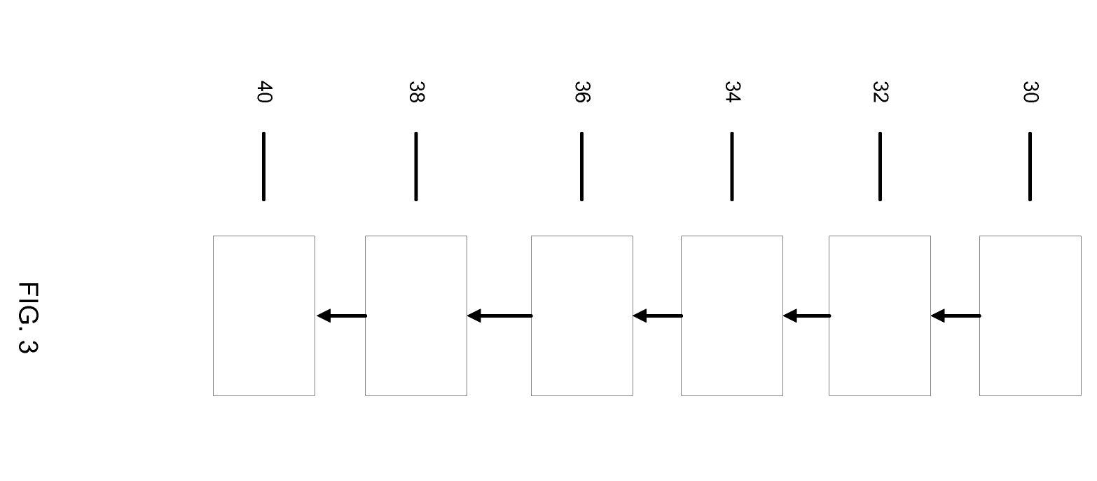

Referring to FIG. 3, an exemplary method for producing a stable RF communications wavefront can include generating a data signal in step 30; combining the data signal with an excitation signal to produce a modulated signal in step 32; generating a modulated photon wave associated with the modulated signal in step 34; directing the modulated photon wave to an incident surface of an charge transformer in step 36; transforming the modulated photon wave within the charge transformer in step 38; and generating a broadband wavefront at an exit surface of the charge transformer in step 40.

In an exemplary embodiment, the combining step 32 may take the form of superimposing the data signal upon a signal composed of a square wave riding on a DC voltage level. The modulated photon wave generating step 34 may use, without limiting the scope of the invention, a magnetron as is known in the art or other energy emission devices, such as discharges or arcs at edges of planar antennae.

In an exemplary embodiment, transforming the modulated photon wave within the charge transformer can include laterally aligning the photons in the modulated photon wave to produce a polarization of that modulated photon wave. This can be accomplished, for example, by manipulating electron speed of the photons, i.e. slowing the electron speeds to release energy in the form of the broadband wavefront. By controlling the design parameters of the charge transformer, desired communication characteristics may be enhanced.

In an exemplary embodiment, a feature can be that the spectral range of the transmissions using the disclosed embodiments can be higher, and thus more removed from known RF communications system frequency bands. In addition to being in a currently unregulated spectral region, such a system can be less affected by interference from such known systems operating in the same space. Conversely, in an exemplary embodiment, this can additionally render the disclosed embodiments nearly undetectable by conventional RF receiver equipment.

In an exemplary embodiment, a communications system can feature enhanced signal carrier performance using a between charged particle emitter to generate a plurality of energized particles to an excitation level that can be uniquely associated with the data signal being transmitted. The energized particles can then be directed toward a charge transformer that can have dielectric and physical characteristics such that a wavefront of zero-charge particles can be formed at the output of the charge transformer, which propagates toward and is received by a receiver. A feature of such a an energized particle wave transmission device is that the generated wavefront can be extremely broadband in nature and can allow communications systems to operate at frequencies up to 300 GHz, for example, which can be significantly above the spectrum of known RF bands, the higher bands currently being unpopulated and thus unregulated.

In an embodiment, a method for generating a highly permeable stable broadband RF wavefront includes generating a modulated EM wavefront incorporating a data signal to be transmitted. The modulated EM wavefront can then be directed through a charge transformer. Within the charge transformer, the EM wavefront can be transformed such that the photons become laterally aligned or polarized, which when impinging on an opposing exit surface of the charge transformer, generate a broadband wavefront containing the data signal being transmitted.

This broadband wavefront can behave in a manner that can be described by particle quantum physics rather than by typical communications theory, and can be characterized as being relatively immune to traditional RF interference. By controlling the configuration and material characteristics of the charge transformer, the wavefront of the transformed EM radiation can be made highly stable, such that it is suitable for use as a data carrier.

The above description is presented to enable a person skilled in the art to make and use the systems and methods described herein, and is provided in the context of a particular application and its requirements. Various modifications to the embodiments will be readily apparent to those skilled in the art, and the generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. A method for producing a stable communications wavefront, comprising:
generating a modulated photon wave associated with a modulated data signal, the modulated photon wave comprising plural energized particles;
directing the modulated photon wave to an incident surface of a charge transformer;
transforming the plural energized particles within the charge transformer, wherein the transformed particles are at substantially zero charge; and
generating a wavefront at an exit surface of the charge transformer comprising the transformed particles at substantially zero charge.

2. The method of claim 1, wherein generating the modulated photon wave occurs in a magnetron.

3. The method of claim 1, wherein generating the modulated photon wave occurs at a planar antenna.

4. The method of claim 1, wherein transforming the modulated photon wave within the charge transformer comprises laterally aligning the photons to produce a polarization of the photon wave.

5. The method of claim 4, wherein polarization of the photon wave is implemented by manipulating electron speed of the photons.

6. A method for producing a stable communications wavefront, comprising:
generating a data signal;
combining the data signal with an excitation signal to produce a modulated signal;
generating a modulated photon wave associated with the modulated signal, the modulated photon wave comprising plural energized particles;
directing the modulated photon wave to an incident surface of a charge transformer;
transforming the plural energized particles within the charge transformer, wherein the transformed particles are at substantially zero charge; and
generating a broadband wavefront at an exit surface of the charge transformer.

7. The method of claim 6, wherein transforming the modulated photon wave within the charge transformer comprises laterally aligning the photons to produce a polarization of the photon wave.
